(19) United States
(12) Patent Application Publication
(10) Pub. No.: US 2019/0215027 A1
(43) Pub. Date: Jul. 11, 2019

(54) EXTERNAL ANTENNA AND WIRELESS COMMUNICATION SYSTEM

(71) Applicant: PEGATRON CORPORATION, Taipei City (TW)

(72) Inventor: Jain-Rung Lo, Taipei City (TW)

(73) Assignee: PEGATRON CORPORATION, TAIPEI CITY (TW)

(21) Appl. No.: 16/242,952

(22) Filed: Jan. 8, 2019

(30) Foreign Application Priority Data
Jan. 9, 2018 (TW) 107100817

(51) Int. Cl. H04B 1/401; H04B 1/00; H04W 52/42; H04B 1/50; H04B 1/44; H04L 12/40

(52) U.S. Cl. CPC H04B 1/401; H04B 1/0064; H04L 12/40045; H04B 1/50; H04B 1/44; H04W 52/42

(57) ABSTRACT

An external antenna adapted to a communication host and a wireless communication system are provided. The wireless communication system includes the external antenna and the communication host. The external antenna includes a first antenna element, a second antenna element, a logic determination circuit and a switching circuit. The first antenna element is configured to receive a wireless signal when the communication host operates in a reception mode. The second antenna element is configured to transmit the wireless signal when the communication host operates in a transmission mode. The logic determination circuit coupled to the communication host is configured to determine whether the communication host operates in the reception mode or the transmission mode so as to generate a determination result. The switching circuit, coupled to the logic determination circuit, is configured to selectively couple to the first antenna element or the second antenna element based on the determination result.

### CROSS-REFERENCE TO RELATED APPLICATION

This application claims the priority benefit of Taiwan application serial no. 107100817, filed on Jan. 9, 2018. The entirety of the above-mentioned patent application is hereby incorporated by reference herein and made a part of this specification.

### BACKGROUND

### Technical Field

The invention relates to a wireless network communication technology, and in particular, to an external antenna and a wireless communication system capable of enhancing active reception capability.

### Description of Related Art

With the popularity of network communication, there are more and more places providing wireless access points (WAP) with wireless broadband (Wireless LAN: WLAN) to support wireless internet environment. In general, wireless base stations have signal instability at the edge of the signal range. In particular, since the transmission power of remote clients (such as mobile phones, notebook computers, etc.) is often smaller than that of wireless base stations, which may cause the wireless signal received from the remote client too weak to be recognized even when the transmitted signal is within the signal range of the wireless base station. Therefore, to increase the signal receiving capability of a wireless base station while applying existing material components and not violating communication regulations has become an important issue.

### SUMMARY

The invention provides an external antenna and a wireless communication system, and the external antenna is capable of enhancing active receiving capability so as to improve the receiving capability and communication quality of the wireless communication system under the condition of low cost and convenient use.

An external antenna, according to an embodiment of the invention, adapted to be coupled to a communication host, includes a first antenna element, a second antenna element, a logic determination circuit, and a switching circuit. The communication host can operate in a reception mode and a transmission mode. The first antenna element is configured to receive a wireless signal when the communication host operates in the reception mode. The second antenna element is configured to transmit the wireless signal when the communication host operates in the transmission mode. The logic determination circuit determines whether the communication host is operating in the reception mode or the transmission mode, and generates a determination result. The switching circuit is coupled to the logic determination circuit to selectively couple to the first antenna element or the second antenna element according to the determination result.

A wireless communication system according to an embodiment of the invention includes a communication host and an external antenna, and the external antenna is coupled to the communication host. The external antenna includes a first antenna element, a second antenna element, a logic determination circuit and a switching circuit. The first antenna element is configured to receive a wireless signal when the communication host operates in a reception mode. The second antenna element is configured to transmit a wireless signal when the communication host operates in a transmission mode. The logic determination circuit determines whether the communication host is operating in the reception mode or the transmission mode, and generates a determination result. The switching circuit is coupled to the logic determination circuit to selectively couple to the first antenna element or the second antenna element according to the determination result.

Based on the above, the external antenna of the embodiment of the invention is coupled to the communication host. The external antenna includes the first antenna element for receiving a wireless signal transmitted by the remote client, and the second antenna element for transmitting a wireless signal to the remote client, the logic determination circuit and the switching circuit. The logic determination circuit determines whether the communication host is operating in the transmission mode or the reception mode, and transmits the determination result to the switching circuit to switch between the first antenna element and the second antenna element. In another embodiment of the invention, a wireless communication system including the external antenna described above and the communication host is provided. Therefore, the external antenna and the wireless communication system of the embodiments of the invention have the capability of enhancing the received signal, and can improve the reception capability and communication quality of the wireless communication system under the conditions of applying existing material components, not violating communication regulations, and convenient use.

The above described features and advantages of the invention will be more apparent from the following description.

### BRIEF DESCRIPTION OF THE DRAWINGS

FIG. 1A is a side view of a wireless communication system according to an embodiment of the invention.

FIG. 1B is a schematic diagram of the wireless communication system according to the embodiment of FIG. 1A from another perspective.

FIG. 2A is a perspective view of a block diagram of an external antenna according to an embodiment of the invention.

FIG. 2B is a schematic diagram showing a circuit structure of an external antenna according to an embodiment of the invention.

FIG. 3 is a close-up view of an input/output interface of an external antenna according to an embodiment of the invention.

FIG. 4 is a schematic diagram of a logic determination circuit according to an embodiment of the invention.

### DETAILED DESCRIPTION

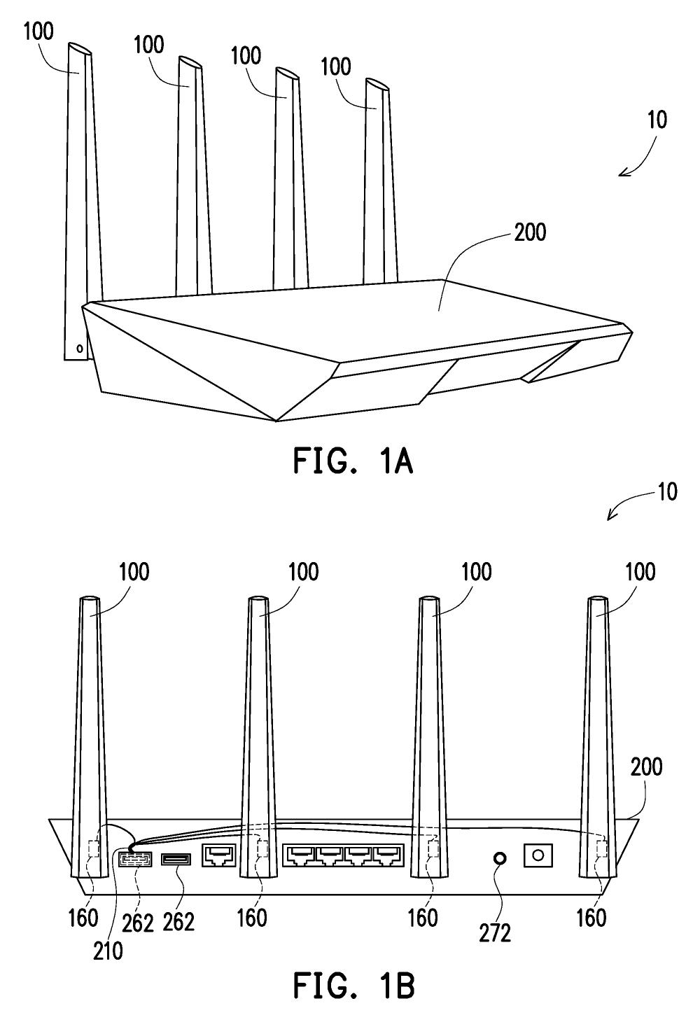

FIG. 1A is a side view of a wireless communication system according to an embodiment of the invention, and FIG. 1B is a schematic diagram of the wireless communication system according to the embodiment of FIG. 1A from another perspective. As shown in FIG. 1A and FIG. 1B, a wireless communication system 10 includes at least one external antenna 100 and a communication host 200, and the external antenna 100 is coupled to the communication host 200. In this embodiment, the external antenna 100 can be an external antenna for enhancing active reception. Four external antennas 100 are shown as an example in the figures, but the invention does not limit the number of antennas.

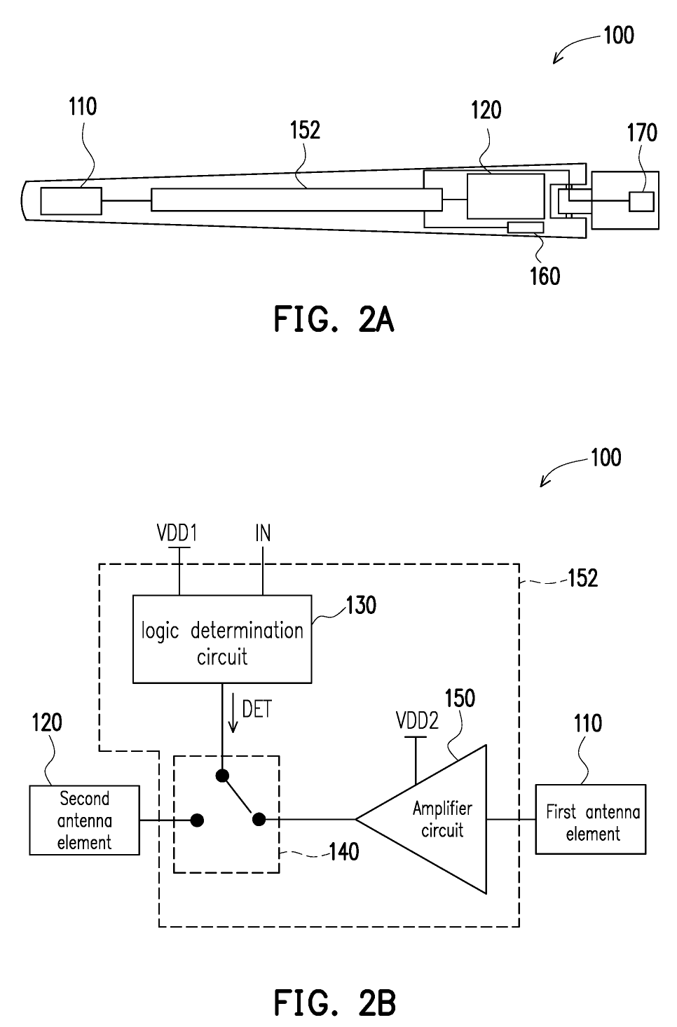

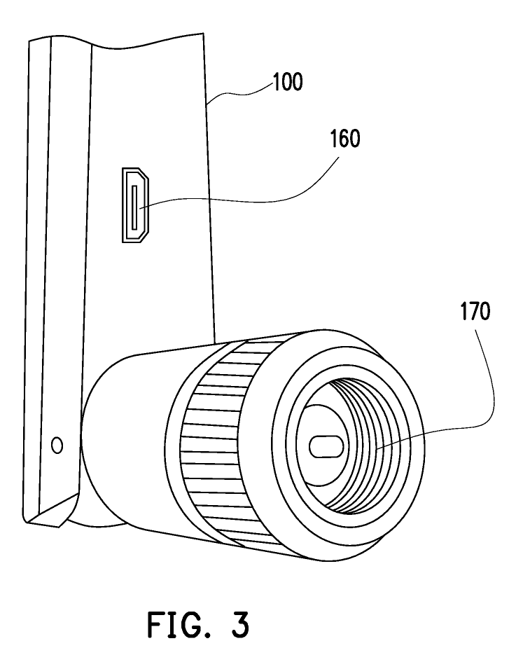

FIG. 2A is a perspective view of a block diagram of an external antenna according to an embodiment of the invention, FIG. 2B is a schematic diagram showing a circuit structure of an external antenna according to an embodiment of the invention, and FIG. 3 is a close-up view of an input/output interface of an external antenna according to an embodiment of the invention. Please refer to FIG. 2A to FIG. 3 in conjunction with FIGS. 1A and 1B.

In the present embodiment, the external antenna 100 includes a first antenna element 110, a second antenna element 120, and a communication circuit 152, wherein the first antenna element 110 and the second antenna element 120 are disposed at the opposite ends of the external antenna 100 in the extended direction (as shown in FIG. 2A). As shown in FIG. 2B, the communication circuit 152 includes a logic determination circuit 130, a switching circuit 140, and an amplifier circuit 150. The logic determination circuit 130 is coupled to the communication host 200, and the logic determination circuit 130 is configured to transmit a wireless signal from the communication host 200 and determine whether the communication host 200 is operating in a reception mode or a transmission mode so as to generate a determination result. The switching circuit 140 is coupled to the logic determination circuit 130 for switching between the first antenna element 110 and the second antenna element 120 to connect the logic determination circuit 130 according to the determination result. The amplifier circuit 150 is coupled between the first antenna element 110 and the switching circuit 140.

When the external antenna 100 receives a wireless signal from a remote client, this situation is referred to as the reception mode hereinafter, and when the external antenna 110 transmits a wireless signal which the communication host 200 desires to send to the remote client, this situation is referred to as the transmission mode hereinafter.

In the transmission mode, the logic determination circuit 130 turns on the second antenna element 120 through the switching circuit 140, and the first antenna element 110 is open. The communication host 200 transmits the wireless signal to the remote client through the second antenna element 120.

In the reception mode, the logic determination circuit 130 turns on the first antenna element 110 through the switching circuit 140, and the second antenna element 120 is open. The communication host 200 receives the wireless signal of the remote client through the first antenna element 110 and transmits it to the amplifier circuit 150. The amplifier circuit 150 amplifies the wireless signal received by the first antenna element 110 to improve the reception capability of the wireless communication system 10. In detail, the first antenna element 110 converts the received wireless signal, and then the amplifier circuit 150 amplifies the wireless signal to increase the received signal strength. Therefore, the communication host 200 receives the signal amplified by the amplifier circuit 150 to improve the reception capability of the wireless communication system 10. That is, the external antenna with the amplifier circuit 150 is capable of enhancing the reception capability.

Implementation of embodiments of the invention will be described in further detail below.

The communication host 200 is, for example, a wireless access point, a wireless router, a bridge, a gateway, a customer premises equipment (CPE), or other network transmission devices capable of wireless communication, and is not limited herein.

The external antenna 100 uses the first antenna element 110 or the second antenna element 120 to receive or transmit wireless signals. In an embodiment, the first antenna element 110 or the second antenna element 120 may be, for example, a dual-band antenna, and cover a first frequency band and a second frequency band, wherein the antenna structures of the first antenna element 110 and the second antenna element 120 may be the same or different. For example, in an embodiment, the first antenna element 110 or the second antenna element 120 (or both) may cover the 2.4 GHz band (i.e., the first frequency band) and the 5 GHz band (i.e., the second frequency band). In other words, in an embodiment, the external antenna 100 can support operating frequency bands under WiFi and Bluetooth communication technologies. That is, the external antenna 100 can be, for example, a WiFi antenna covering the 2.4 GHz band and the 5 GHz band.

In the embodiment of FIG. 2A, in order to avoid board noise or signal interference, the first antenna element 110 responsible for the reception mode is disposed at the upper end of the external antenna 100, and the second antenna element 120 responsible for the transmission mode is disposed at the bottom end of the external antenna 100. Specifically, the first antenna element 110 is disposed at one end of the external antenna 100 away from the communication host 200 while the second antenna element 120 is disposed at the other end of the external antenna 100 near the communication host 200.

In the present embodiment, the external antenna 100 further includes a first input/output interface 160. The first input/output interface 160 is a female connector for connecting with a bus of the communication host 200 to receive a DC/AC (direct current/alternating current) power supply. The DC/AC power supply can provide the driving voltage VDD2 for the amplifier circuit 150. Specifically, the first input/output interface 160 may adopt physical power transmission line, such as a power supply hole, a Type-C interface, or a Universal Serial Bus (USB) interface, or may be used to receive wireless power transmission. The charging interface is not limited by the invention. In the embodiment of FIG. 3, the first input/output interface 160 is exemplified by a Micro Universal Serial Bus (Micro USB) interface.

Referring to FIG. 1 in conjunction with FIG. 3, in the embodiment, the wireless communication system 10 further includes a transmission line 210 electrically connected to the communication host 200 and the external antenna 100. One end of the transmission line 210 is connected to one of the input/output (input and output) interfaces 262 of the communication host 200. The other end of the transmission line 210 is connected to the first input/output interface 160 for supplying DC/AC power from the communication host 200 to the external antenna 100. For example, the transmission line 210 is a USB or Micro USB transmission line (but is not limited thereto). That is, the transmission interface of the transmission line 210 for connecting the communication host 200 is the standard Universal Serial Bus interface, and the transmission interface for connecting to the external antenna 100 is the Micro USB interface. In this embodiment, the transmission line 210 is a transmission line of one USB connector to four Micro USB connectors, and therefore the plurality of external antennas 100 can be powered by only one input/output interface 262. However, the number of the transmission line 210 is not limited to one. In other embodiments, one input/output interface 262 can supply power to only one external antenna 100.

It is to be noted that the positions and implementation of the first input/output interface 160 and the input/output interface 262 in the drawings are merely illustrative and are not intended to limit the invention.

In the embodiment, the second input/output interface 170 of the external antenna 100 is coupled to the signal input/output interface 272 of the communication host 200 for performing signal transmission with the communication host 200. The logic determination circuit 130 transmits the wireless signal through the second input/output interface 170, and the first input/output interface 160 and the second input/output interface 170 are two separate interfaces. The second input/output interface 170 is, for example, an SMA (Sub Miniature version A) connector, a BNC (Bayonet Neill-Concelman) connector or an N-Type connector, or any other connector component for receiving a wireless signal, which is not limited by the invention.

According to the above embodiment, the external antenna 100 is electrically connected to the communication host 200 through the first input/output interface 160 and the second input/output interface 170. That is, the external antenna 100 and the communication host 200 are separable. Therefore, the external antenna 100 of the invention does not need to be bound to a specific communication host 200. In addition, the antenna of the commercially available communication host can also be replaced with the external antenna 100 of the invention, thereby enhancing the connection quality and connectivity of the communication host 200 as well as using existing material components, no violating communication regulations, and saving the cost.

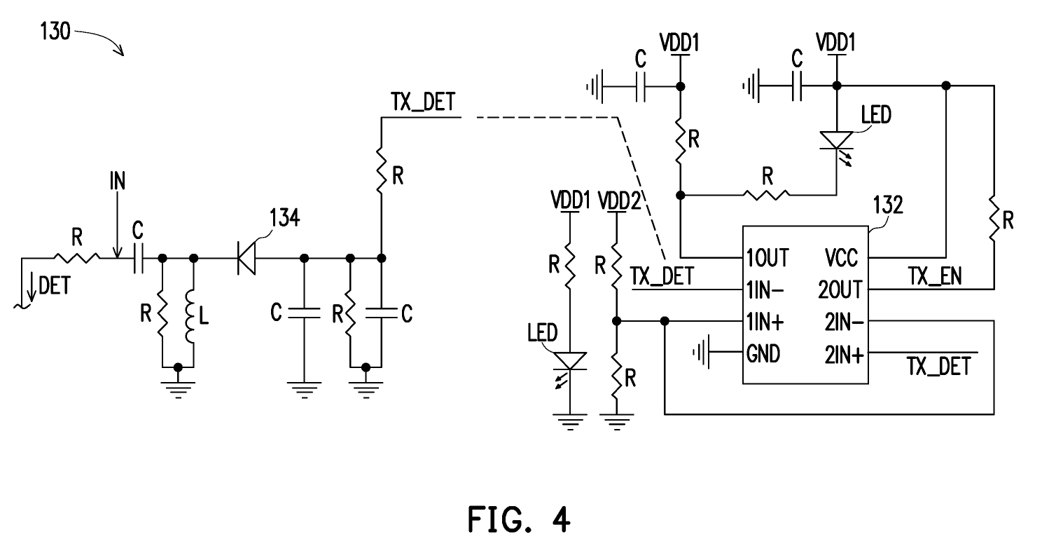

FIG. 4 is a schematic diagram of a logic determination circuit according to an embodiment of the invention. The logic determination circuit shown in FIG. 4 can be applied to the above embodiment. Referring to FIG. 4 in conjunction with FIG. 2B, the logic determination circuit 130 may transmit the wireless signal through the second input/output interface 170. That is, the wireless signal is input via the input terminal IN in FIG. 2B. The logic determination circuit 130 may receive the DC power (for example, 5V) through the first input/output interface 160, which is the terminal VDD1 in FIG. 2B. The logic determination circuit 130 could determine whether the wireless signal indicates the communication host 200 to operate in the reception mode or the transmission mode, and thus generate the determination result DET. Specifically, in the embodiment of FIG. 4, the logic determination circuit 130 includes a diode 134 and a comparator 132. The comparator 132 is coupled to the communication host 200, and the diode 134 is coupled between the comparator 132 and the switching circuit 140. The switching circuit 140 is, for example, a radio frequency switch. The comparator 132 receives the DC/AC power (i.e. the driving voltages VDD1 and VDD2) supplied from the communication host 200 through the first input/output interface 160. For example, the driving voltage VDD1 is 5V, and the driving voltage VDD2 is 3.3V (but are not limited thereto).

In the embodiment, the comparator 132 further receives the wireless signal under test TX_DET provided by the communication host 200 through the second input/output interface 170, and compares the enable signal TX_EN with the wireless signal under test TX_DET to determine whether the received wireless signal under test TX_DET indicates the reception mode or the transmission mode. The diode 134 receives the wireless signal under test TX_DET and converts it into a voltage signal (i.e., the determination result DET). The logic determination circuit 130 provides a determination result DET to the switching circuit 140. The switching circuit 140 switches between the reception mode and the transmission mode according to the determination result DET. In details, in an embodiment, when the determination result DET is at low level (e.g., a logic low level), the switching circuit 140 switches to the first antenna element 110 and enters the reception mode, and when the determination result DET is at high level (e.g., a logic high level), the switching circuit 140 switches to the second antenna element 120 and enters the transmission mode.

In particular, the plurality of resistors R, the plurality of capacitors C or the inductors L and the circuit structure used in FIG. 4 are only used as an embodiment of the circuit, and are not intended to limit the invention. The resistance values of the plurality of resistors R are not necessarily the same, and the capacitance values of the plurality of capacitors C are not necessarily the same. Those skilled in the art can obtain sufficient instructions and recommendations from the circuit architecture of FIG. 4 and the ordinary knowledge of the technical field, and thus no further description will be provided below.

The following is an experimental result of an embodiment of the invention. Under the condition of the same communication host and the same remote client, the signal transmission and reception capabilities of the original antenna of the communication host and the external antenna 100 are tested at different distances. Here, the communication host is the router TP-Link Archer C2, and the remote client is the ASUS notebook X550V, and the number of antennas is two.

Tables 1 and 2 show the signal transmission and reception capabilities tested at frequency bands of 2.4 G HZ and 5 G HZ, respectively. The communication host and the remote client are 30 meters and 50 meters apart. TX is the network transmitting speed and RX is the network receiving speed.

TABLE 1

| | Network Transmission | | |
|---|---|---|---|
| Frequency 2.4 G | Speed | 30 meters | 50 meters |
| Original Antenna | TX(Mbps) | 66.325 | 10.325 |
| | RX(Mbps) | 60.554 | 3.995 |
| External Antenna | TX(Mbps) | 65.398 | 9.866 |
| | RX(Mbps) | 63.114 | 8.687 |

TABLE 2

| | Network Transmission | | |
|---|---|---|---|
| Frequency 5 G | Speed | 30 meters | 50 meters |
| Original Antenna | TX(Mbps) | 135.263 | 26.712 |
| | RX(Mbps) | 119.445 | 13.365 |
| External Antenna | TX(Mbps) | 133.922 | 25.677 |
| | RX(Mbps) | 128.352 | 21.964 |

From the experimental results, when the original antenna of the same communication host is replaced with the external antenna according to the embodiment of the invention, the capability of wireless signal reception and the quality of the connection have significantly improved, especially in a long distance.

In summary, the external antenna and the wireless communication system of the embodiment of the invention is provided. The external antenna is coupled to the communication host, and includes a first antenna element, a second antenna element, a logic determination circuit, an amplifier circuit, and a switching circuit. The logic determination circuit determines whether the communication host is to receive the wireless signal or to transmit the wireless signal, and sends the determination result to the switching circuit to switch to the first antenna element or the second antenna element. The first antenna element is configured to receive the wireless signal, and the second antenna element is configured to transmit the wireless signal, thus the wireless signal is received and transmitted by two respective sets of antenna elements. Moreover, the first antenna element and the second antenna element are disposed at the opposite ends of the external antenna in the extended direction, thereby reducing noise and improving communication quality. The wireless signal received by the first antenna element is then amplified by the amplifier circuit, so the signal reception capability can be improved under low power consumption conditions. In addition, since the external antenna can be easily detached or attached with the communication host, it can be paired with different communication hosts to enhance the application flexibility. Therefore, the external antenna and the wireless communication system of the embodiments of the invention can improve the signal reception capability and communication quality as well as have advantages of using existing material components, low cost and convenient use without violating communication regulations.

Although the invention has been disclosed in the above embodiments, it is not intended to limit the invention, and it is intended that the invention may be practiced otherwise without departing from the spirit and scope of the invention. The scope of protection of the invention is defined by the scope of the appended claims.

What is claimed is:

1. An external antenna, adapted for a communication host operating between a reception mode and a transmission mode, the external antenna comprising:
a first antenna element, configured to receive a wireless signal when the communication host operates in the reception mode;
a second antenna element, configured to transmit the wireless signal when the communication host operates in the transmission mode;
a logic determination circuit, coupled to the communication host and configured to determine whether the communication host operates in the reception mode or the transmission mode and generate a determination result; and
a switching circuit, coupled to the logic determination circuit and configured to selectively couple to the first antenna element or the second antenna element according to the determination result.

2. The external antenna according to claim 1, wherein the first antenna element and the second antenna element are disposed at opposite ends of the external antenna in an extended direction.

3. The external antenna according to claim 1, further comprising:
an amplifier circuit, coupled between the first antenna element and the switching circuit and configured to amplify the wireless signal received by the first antenna element.

4. The external antenna according to claim 1, wherein the logic determination circuit comprises a diode and a comparator, and the comparator is coupled to the communication host and the diode is coupled between the comparator and the switching circuit.

5. The external antenna according to claim 1, wherein the switching circuit is coupled to the first antenna element when the determination result is at low level, and the switching circuit is coupled to the second antenna element when the determination result is at high level.

6. The external antenna according to claim 1, wherein the first antenna element is disposed at an end of the external antenna away from the communication host, and the second antenna element is disposed at the other end of the external antenna near the communication host.

7. The external antenna according to claim 1, further comprising:
a first input/output interface, coupled to the communication host and configured to receive direct current power from the communication host; and
a second input/output interface, coupled to the communication host and configured to receive the wireless signal from the logic determination circuit.

8. The external antenna of claim 1, wherein the first antenna element and the second antenna element cover a first frequency band and a second frequency band.

9. A wireless communication system, comprising:
a communication host; and
the external antenna, according to claim 1, coupled to the communication host.

10. The wireless communication system according to claim 9, further comprising:
a transmission line, electrically connecting the communication host with the external antenna and configured to supply power from the communication host to the external antenna, wherein a transmission interface of the transmission line for connecting the communication host is a standard Universal Serial Bus (USB) interface and a transmission interface of the transmission line for connecting the external antenna is a Micro Universal Serial Bus (Micro USB) interface.
